(19) United States
(12) Patent Application Publication
(10) Pub. No.: US 2010/0072746 A1
(43) Pub. Date: Mar. 25, 2010

(54) Universal saddletap fitting for H.V.A.C. duct

(76) Inventor: Gary Andrew Jensen, Napa, CA (US)

Correspondence Address: GARY ANDREW JENSEN, 268 COUNTRY CLUB LN, NAPA, CA, 94558, US

(21) Appl. No.: 12/586,436

(22) Filed: Sep. 22, 2009

Related U.S. Application Data
(60) Provisional application No. 61/192,904, filed on Sep. 23, 2008.

(51) Int. Cl. F16L 25/00

(52) U.S. Cl. 285/197

(57) ABSTRACT

The purpose is to extract a large volume of regulated conditioned air thru use of a saddle tap fitting made of sheet metal, and for tightly attaching a HVAC branch line to a circular or arcuate sides of a flat or short sections of pipe as well as tapers, reducers or oval main trunk lines and their fittings of many different sizes at an angle. This fitting includes 2 cylindrical collars rotatably attached to a body having a skirt which flexibly conforms, to the arcuate surface to which it is attached. Manually rotating the two canted collars smoothly changes the angles and compound angles, to the branch lines from a range of approx 107 degrees when attached to the main line thus directing a controlled volume of conditioned air to desired locations all of this can be achieved with the use of this one fitting.

This application claims the benefit of priority of provisional patent application 61/192,904 the was filed on Sep. 23, 2008 and entitled “H.V.A.C. Saddle tap Fitting with Two Rotatable Elbow Gores and Adjustable Air Extractor”.

### BACKGROUND OF THE INVENTION

1. Field of the Invention

The present invention relates to ducting for heating, ventilating, and air conditioning HVAC systems and more particular to a sheet metal fitting for connecting a round branch line by tapping into a round main trunk line and it's fittings of many different sizes.

2. Description of the Related Art

Rectangular duct and fittings are widely used because they are easy to build and they can be easily sized to fit in tight spaces such as ceiling and walls.

But airflow is less than for equivalent round or flat oval pipe.

Rectangular trunk lines and their taps are easy to build.

One of the many problems with rectangular duct is it generally can be built in only 4 foot or 5 foot lengths.

As spiral round or oval can be made and hung in 20 foot lengths saving many connections, labor and material as well. Rectangular duct is weaker than round duct, it needs more support, costing even more. Also there are no corners on round or oval pipe therefore leaving more space and more available angles for saddle tap branch lines. Rectangular duct can be easily lined with insulation, but its costly and is subject to erosion into the air stream, which people breath. While round or oval trunk lines, saddle taps, fittings and branch lines can be easily and cheaply wrapped keeping the insulation problems to a minimum.

In the HVAC industry duct take off fittings are used at every branch line tap off the main line, the use of round duct usually available and generally preferred because it is less expensive and stronger and easier to install.

The problem using round pipe for main trunk lines is it is made up of size specific fittings. The size of the main line to the branch lines can vary greatly. These fittings tees and wyes can be supplied by the factory, but it takes a large quantity of various size fittings, that are expensive, complicated to fabricate, stock and ship.

A typical main trunk line enters in the building at a large size, example a 26 inch round travels a few feet then smaller branch lines are needed so a cross tee or wyes fitting such as a 26 inch to a 26 inch to an 8 inch branch would be installed in the main line to service the branch lines.

Then a few more feet of main line duct continues to the next fitting which could be the same size or with another cross tee or wyes installed or through the use of a reducer or fitting could reduce to a smaller size of a 20 inch pipe then a section of 20 inch pipe again a few feet to the next fitting this process would continue on to the next branch lines again and so on to the end of the main trunk line a 10 inch size This process contains a multitude of specific sized fittings which are expensive, have availability, storage and bulk shipping problems and costs.

Presently there are several methods of connecting round main lines to the round branch lines, although in most cases are expensive and size specific and complicated sheet metal pattern to fit the curvature of several sizes of trunk lines are necessary.

2. Description of Prior Art

Paoluccio U.S. Pat. No. 5,080,403-01/14/1992 has a bellows fitting

Is made of multiple materials, fabric and metal and many parts, expensive to make.

Needs interior liner for less turbulent air flow.

Needs brackets to brace or restrain fitting while in use.

Needs to be forced into angles off the main line which would bunch up the bellows fitting causing problems.

Exterior use of this fitting to sunlight would make it rot.

Has many seams to seal.

The use of the fabric bellows gives a foreign appearance with the metals that make up the main trunk line and branch line.

Fabric bellows very weak easily collapsible in or under concrete applications.

To flexible need hangar to support the discharge end to the branch line.

Wachter U.S. Pat. No. 4-147,382-04/03/1979

Has a long narrow slot and can not be nested.

The tap into the main line has to be long in order to have enough volume to supply the branch line it takes to much space.

Cutting in the long slot would weaken the main line.

The long flat sides of the fitting are weak and could collapse when used in concrete under floor applications.

### Current U.S. Class 285/424,285/229,285/189

### Current International Class

### Field of Search 285/229,189,183,138,15,184,114, 123/339.22 285/183 285/181

### PRIOR ART

U.S. Pat. No. 5,080,403—Paoluccio, John A—Jan. 14, 1992
U.S. Pat. No. 4,147,382—Wachter, Eric Apr. 3, 1979
U.S. Pat. No. 5,957,506—Stepp, Michael D.—Sep. 28, 1999
U.S. Pat. No. 5,328,213—Barth James T.—Jul. 12, 1994
U.S. Pat. No. 5,340,160—Meijers et al.—Aug. 23, 1994
U.S. Pat. No. 1,808,450—Paul Burgess Samuel—Jun. 2, 1931
U.S. Pat. No. 4,627,646—Kessel Bernhard—Dec. 9, 1986
U.S. Pat. No. 4,414,943—Nagase, Masscomi—Nov. 15, 1983
U.S. Pat. No. 2,482,558—Scaringella Vito V.—Sep. 20, 1949
U.S. Pat. No. 171,964—Syversen, A—Jan. 11, 1876

### OBJECTS OF THE INVENTION

In view of the foregoing considerations it is an object of the present invention to provide a saddle tap fitting which is tightly adaptable to many sizes of main line round or the arcuate side of flat oval trunk line pipe and its fittings. Extract conditioned air through the tap and regulating the volume of said air through a plurality of degreed elbow gores. Then efficiently direct the conditioned air to a branch line at many different angles and compound angles.

A—With the use of one said tap will reduce the need for complicated specific size fittings and there manufacturing and availability problems.
B—Still another object—Is to tap the main line with a fitting that is naturally angled off the main line for a high volume smooth, less turbulent air flow.
C—Another object is to reduce stocking and availability problems.
D—Another object is—To have a saddle tap that appears to be specifically made for the duct or fitting it is attached to.
E—Another object is tap into short sections of scrap pipe saving resources and environment.
F—Still another object is its strength it can be buried in or under concrete floors won't collapse.
G—Yet another object under said floor application it would distribute air thru out conditioned space better saving energy.
H—Yet another it's small size will take up little space and can be installed in tight spaces and difficult situations.
I—Still another object of this saddle tap it is made up of one material galvanized sheet metal is preferred from. The use of one material saves time and expense. Gauges from 30 to 10 gauge.
J—Still another object is it easy to make not complicated.
K—Another object it can be used in abrasive situations, such as sawdust or dust
L—Another object is it can be made of stainless steel or other materials, PVC coated metals or plastic or etc for corrosive situations.
M—Another it can be deeply nested several sizes completely inside the successive next size saving freight and storage space.
N—Another object it can be soldered water tight.
O—Branch lines can be directed in many angles and compound angles.
P—Another object it can have an interior acoustic coating for sound reduction situations.
Q—A continuing object of the saddle tap fitting and its elbows have degree marks for like situations on body and both collars. The collars can be rotated to identical degree marks for successive saddle taps. When used with a plurality of fittings for consistency of installation and appearance in like exposed or non exposed situations, saving expensive time and labor.
R—Yet another interior air extractor flexibly adapts to the size trunk line it is attached to.
S—A continuing object extractor can be raised or lowered into multiple positions to extract more or less air.
T—Another object is the extractor has dual purpose multi position restraining and use indicator strap. Said strap can indicate to balance technician if this fitting can deliver more or less air as necessary.
U—Another object will reduce the need for complicated specific size fittings.
V—Another object is to reduce shipping expense.
W—A continuing object exterior is easy to clean for housekeeping purposes in exposed situations. Such as restaurants or shops.
X—The appearance is aesthetically pleasing.

### SUMMARY OF INVENTION

These and other objects are met by the present inventions which in the first aspect provides a fitting for attaching an end of a duct section of a relatively small cross section to an arcuate surface of a duct section of a relatively large cross section.

FIG. 4 this invention contains several pieces. A body and skirt in one piece 32 and 33 and two cylindrical collars 26 and 29. The upper body has a bead 31 circumscribing it at the round end. Bead 31 rotateably interlocks with a corresponding bead 30 on collar 29 that is cylindrical and canted at an angle on both ends. The second angle has bead 28 that interlocks with bead 27 of collar 26. When the three pieces are connected they are rotatably attached permanently. When attached to main line then the collars can be rotated to desired angle or compound angles then directed and connected to the branch line. These and other features and advantages of the invention will become further apparent from the detailed description that follows, which is accompanied by drawing figures. In the figures and description, numerals indicate the various features of the invention. Like numerals referring to like features throughout both the drawings and description.

### BRIEF DESCRIPTION OF THE DRAWINGS

The invention will be better understood by reference to accompanying drawings in which,

FIG. 1A—Is side view with the collars rotated to the extreme left position also with extractor strap partially shown with a securing hole in it. Also shown are 4 of the 6 attachment tabs with restraining holes in them. The rivet shown in the body of the fitting is one of two opposing rivets shown which secure as well let the extractor pivot down in to the air stream when attached to main line.

FIG. 1—Identical in position to FIG. 1A on page 1/13

FIG. 2—Shows the two collars rotated to the extreme right when mounted on main line the difference from extreme left to extreme right is 107 degrees approx.

FIG. 3—Shows fitting rotated to 90 degrees position when mounted on main line.

FIG. 4—Shows exploded view of saddle tap fitting and various parts and accompanying reference numbers. Upper right 21 is the threaded wing nut 22 damper quadrant wrench 23 threaded damper quadrant hardware which is affixed to damper blade 24. 25 damper quadrant hardware affixed to damper blade 24. Upper left shows detail of inter locking rotatable collars. In detail space 26 refers to collar 26. In detail space 27 is the bead of collar 26. In detail space 29 is collar 29. In detail space 28 is the bead of 29. In detail space 30 is an additional bead of collar 29. In detail space 31 is the bead for detail 32 which is the upper body of the said fitting 32. The skirt of the fitting is 33. Hole 34 in collar 29 is the hole for damper quadrant 23. Hole 35 in collar 29 is the hole for damper quadrant hardware 25. Tab 36 is a part of the skirt 33, 36 which is an attachment tab for securing the skirt to the main line. 37 is the hole in tab 36. This combination of tabs and holes are typical at skirt base. Shown in detail lower right shows 36 attachment tab and 37 is its hole and 38 is the relief cut notch in the skirt on both sides of tab 36. On the skirt 39 is another attachment tab 40 is the hole in it. This tab and hole is duplicated on the opposite side which is not shown. 41 is one of two stiffening and sealing flanges for the skirt which is duplicated on the opposite side not shown. 42 is another attachment tab 43 is its hole. 44 is another attachment tab in the skirt and 45 is its hole, like tabs and holes are duplicated on the other side not shown. 46 and 47 are securing and pivoting holes in the saddle taps body for the extractor blade 50 which will be later installed inside the body. Hole 48 and 49 in the extractor blade 50 work in conjunction with 47 and 46 respectively. 51 is a crimped edge of extractor blade 50. 52 is the restraining, securing and indicator strap with adjusting and securing holes 53 54 and 55 in it.

FIG. 5—Is an enlarged working view of FIG. 6 for a clearer view. This FIG. 5 is not standard sheet metal layout, but using this method any size can be made A and B are the same length A to X equal the length of line C. The distance from A to V equals line D so if you know the length only of line B this and all other size fitting can be made by this method saving complex layout problems.

FIG. 6—Is a working view necessary for the layout of the fitting. FIG. 7 which is the flat pattern for the saddle taps body and skirt.

FIG. 7—Shows the layout of the fittings pattern, that anyone skilled in the art can understand and layout.

FIG. 8—Is nothing more than FIG. 5 but used in this manner and in conjunction with FIG. 9 the extractor 50 the dark lined pattern can be laid out as well, also to use up material that would normally be scrap off of FIG. 9.

FIG. 9—is the flat pattern of the saddle tap fitting. 50 is the extractor shown with its holes used for pivoting and securing extractor to the body of fitting The 3 holes shown in the extractor strap, to show various three positions the extractor can be adjusted to as well as securing the strap and accompanying extractor in the air stream.

FIG. 10—Is the working view of FIG. 12 the flat pattern layout, which is for collar 29.

FIG. 11—Is the working view of FIG. 13 the flat pattern layout which is for collar 26.

FIG. 12—Is the flat pattern of collar 29 with the two interlocking beads shown.

FIG. 13—Is the flat pattern of collar 26 with only one interlocking bead needed shown.

Page 8 of 13—Shows the saddle tap fittings various flat pattern sheet metal parts cut out with the holes in them before being formed up. Number 26 and number 29 are the collars.

32 is the body of the fitting, 33 is the skirt which is the same piece. 50 is the extractor 51 a crimped edge for the extractor.

FIG. 14—Shows a large elbow with a saddle tap attached to it which shows versatility in some situations.

FIG. 15-Shows three saddle tap fittings loosely nested for clarity with the interior extractors partially shown with their securing straps, with the securing holes in them and the crimped edge on extractors shown. In addition the second collar has one of two holes shown used for the volume damper.

FIG. 16-Shows a lower view of the saddle tap fitting with attachment tabs shown and the two stiffening and sealing flanges one on each side at the base of the skirt. The saddle tap's two collar are rotated to a 90 degree position when attached to the main line. This view also shows the interior air extractor blade which is crimped. In addition the extractors adjusting and restraining strap has three adjusting and restraining holes in it. The black dot in the body of the fitting rivet 46 only one of two is the pivot point and securing point for the extractor. The second collar shows one of the two volume damper pivoting holes in it.

FIG. 17—Shows large pipe with a saddle tap attached and the two elbow gores have been manually rotated at a 90 degree angle off the large pipe.

FIG. 18—Shows small pipe with an inverted saddle tap attached and the two elbow gores have been manually rotated at a 90 degree angle off the small pipe. This also shows tight situations the fitting can adapt to.

FIG. 19—Shows a large reducer with three saddle taps and their elbow gores manually rotated to various angles again to show versatility.

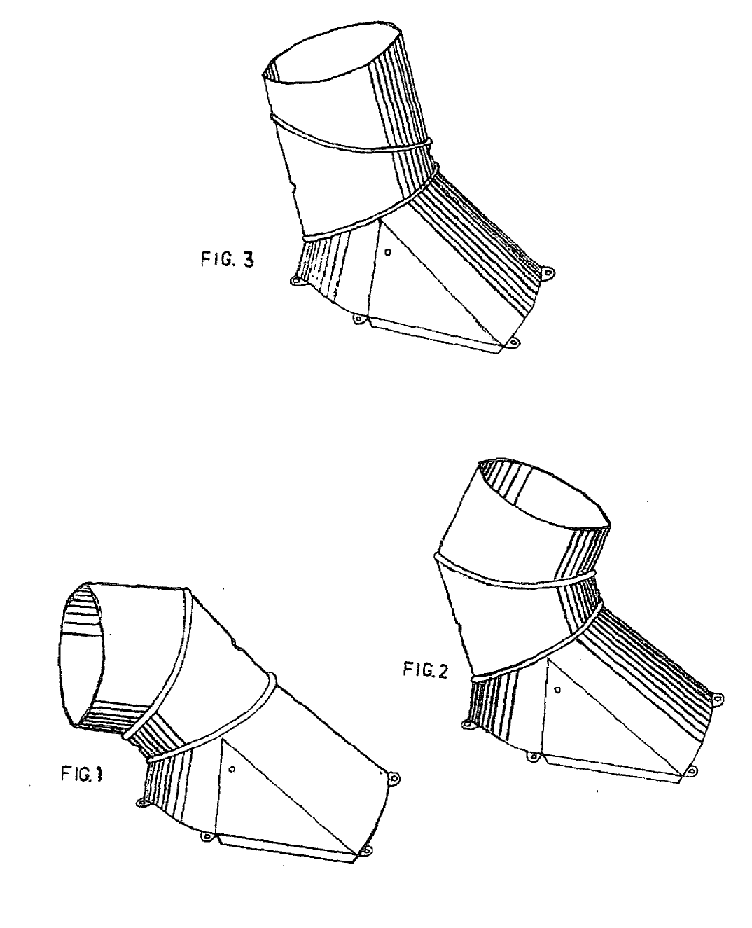

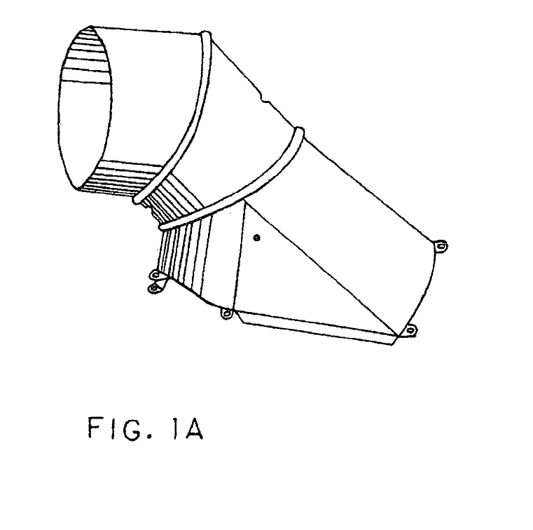

Page 13a shows a large reducing trunk line with many saddle taps of the same size mounted on trunk line and rotated to different angles to show versatility of the saddle tap fitting.

### DESCRIPTION OF PREFERRED EMBODIMENT

While the present invention is open to various modification and alternative constructions, and uses in other industries, the preferred embodiment shown in the drawings will be described here in detail it is to be understood how ever there is no intention to limit the invention to the particular form disclosed. On the contrary it is intended that the invention cover all modifications, equivalences and alternative constructions falling within the spirit and scope of the invention as expressed in the appended claims. The body and the two collars are interlocked in an easily rotatable permanent connection.

This HVAC saddle tap is a simple inexpensive effective method of taping a round branch line to round or arcuate sides of flat oval main trunk lines and their fittings of many different sizes at a small angle off the main line, which gives it a smooth, less turbulent air flow saving energy also the tap size at the main line is much larger than at the discharge to the branch line for a large volume of air. Collar 29 has a volume damper in it to regulate air. Said saddle tap has an interior air extractor for use in long or restricted branch lines which flexibly adapts to the main line or short section of pipe or fitting it is attached to.

The extractor has a multi position depth adjustable securing strap that also serves as a use or depth indicator which is very helpful for the air balance technician.

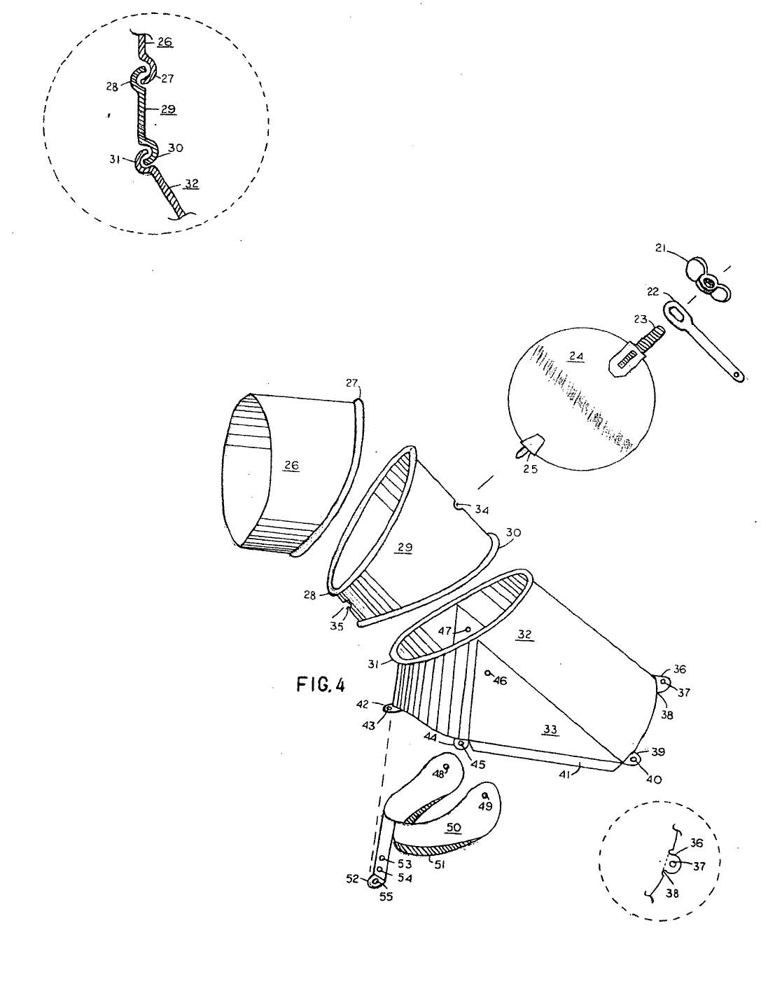

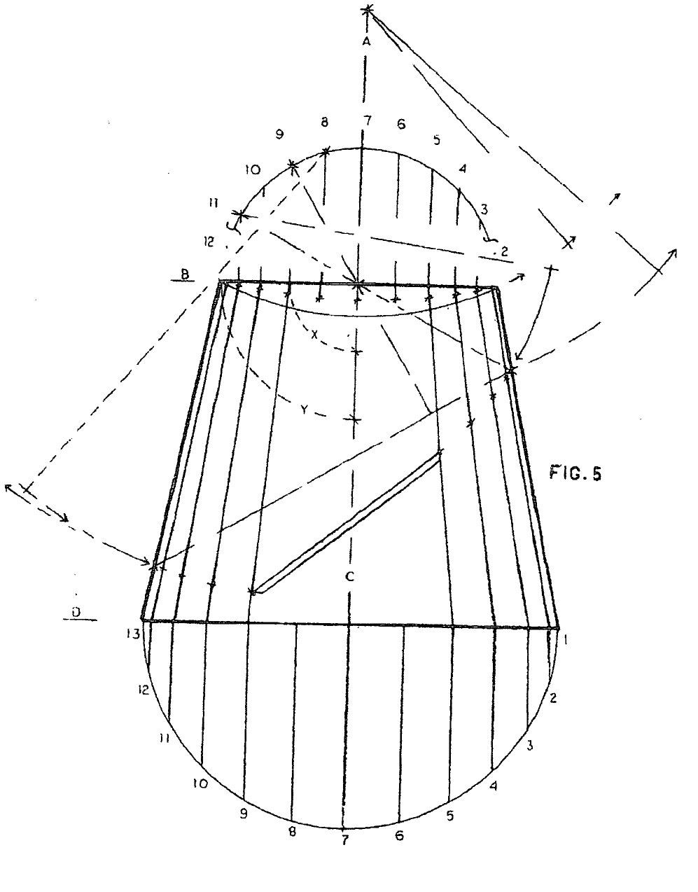

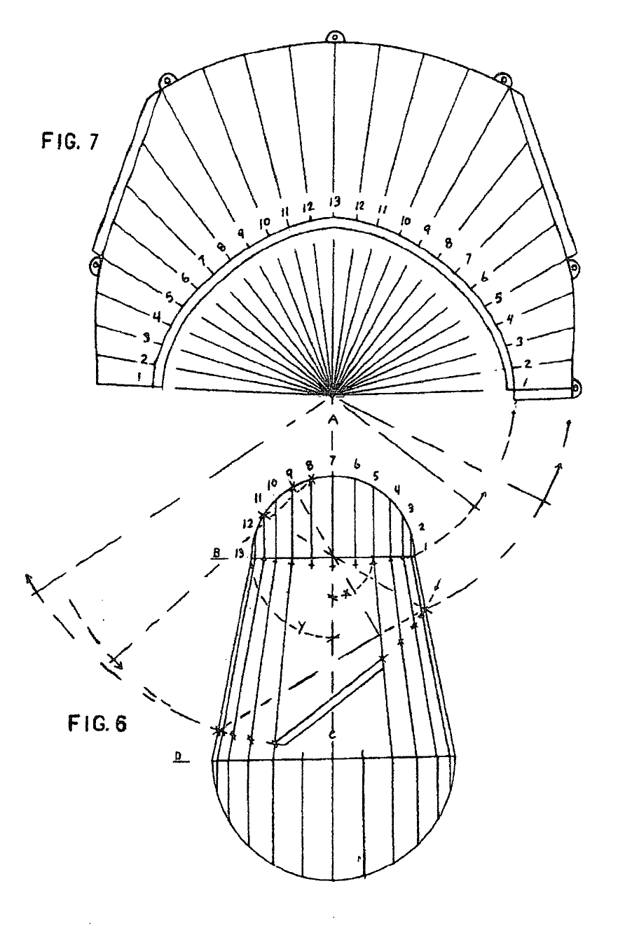

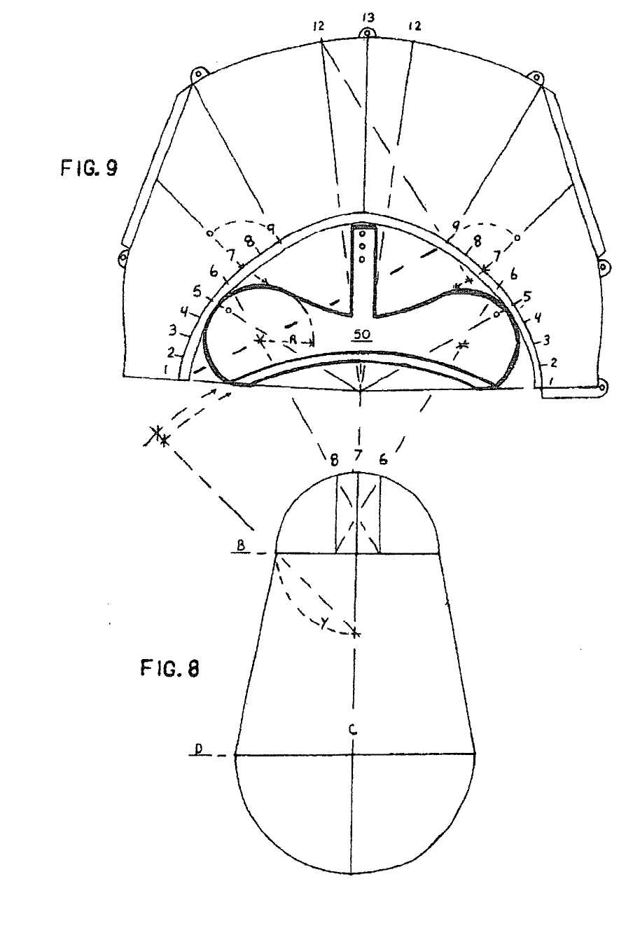

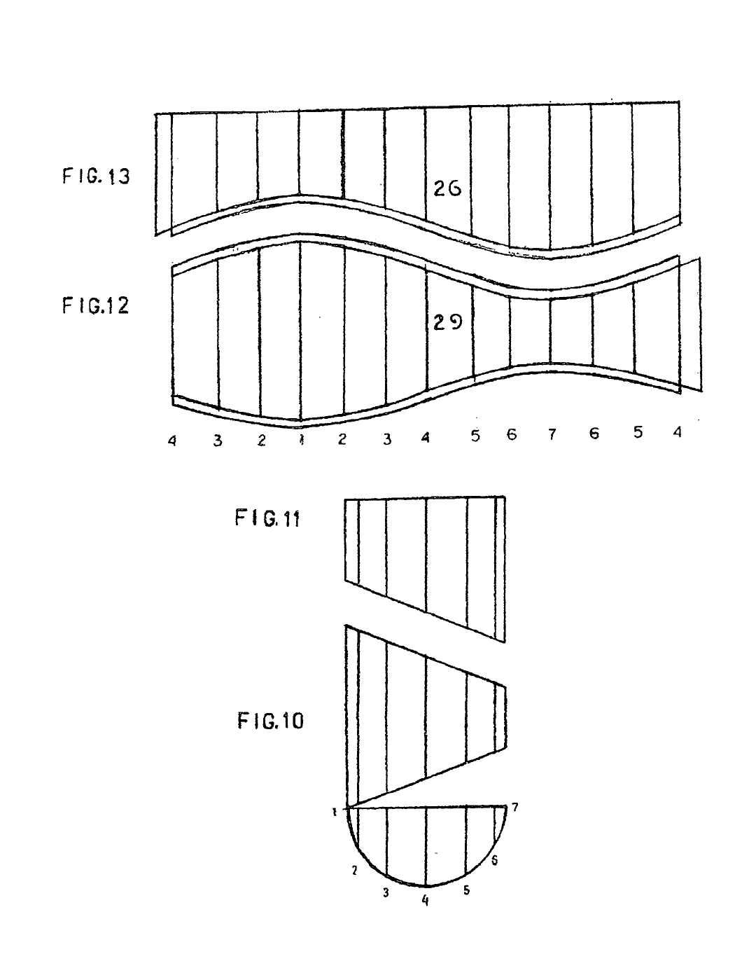

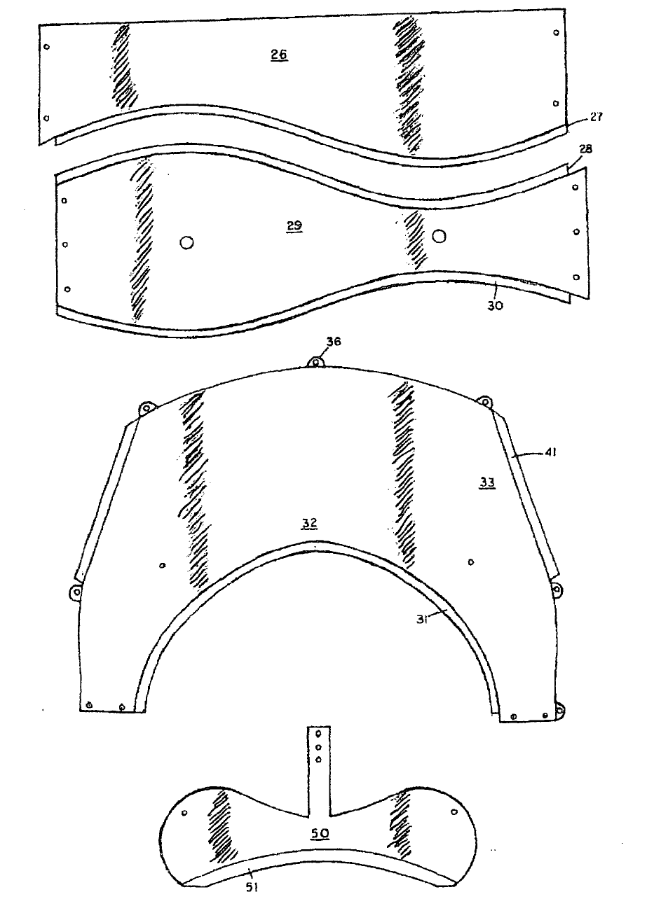

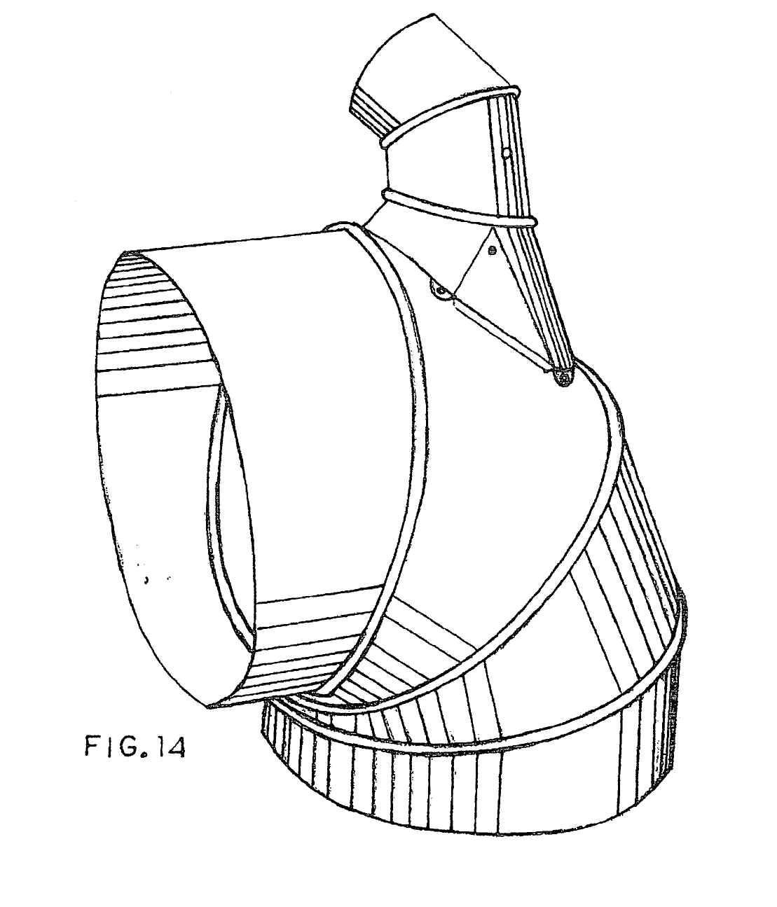

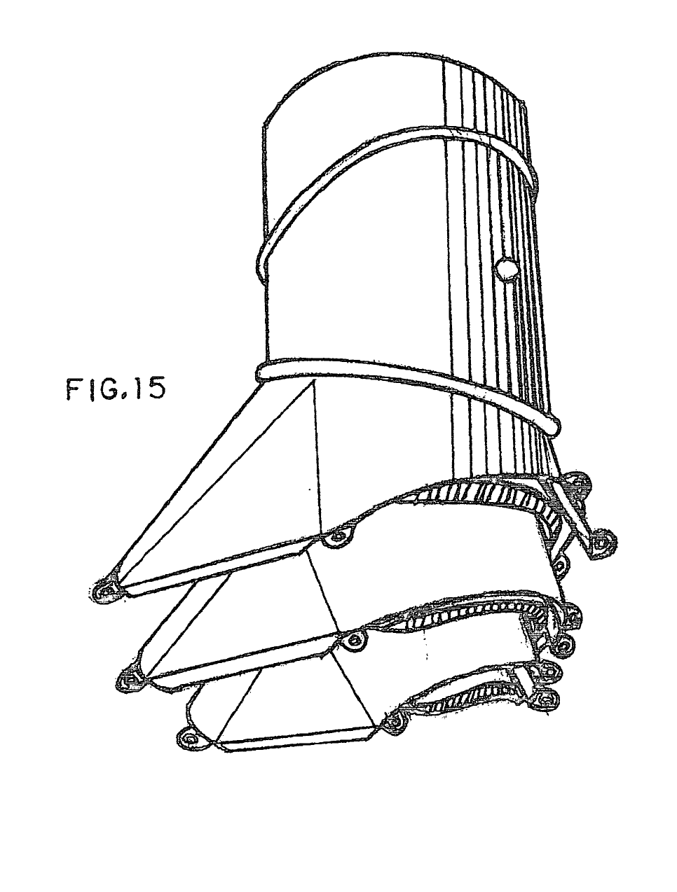

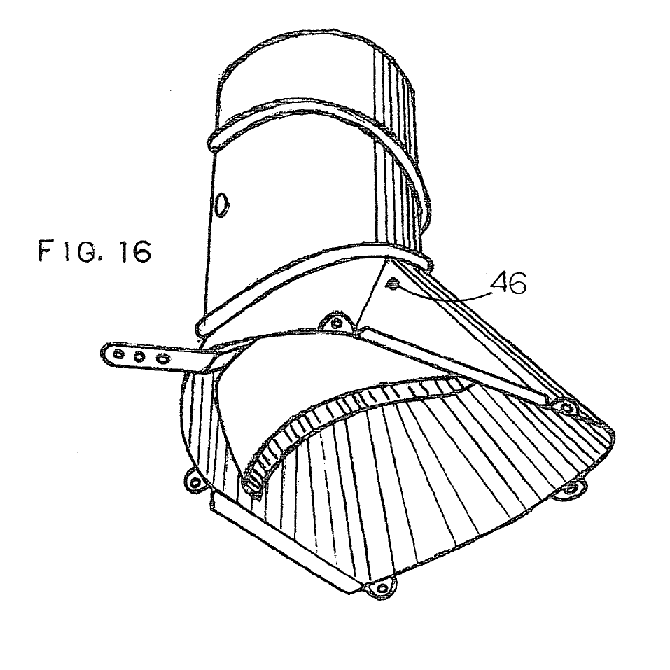

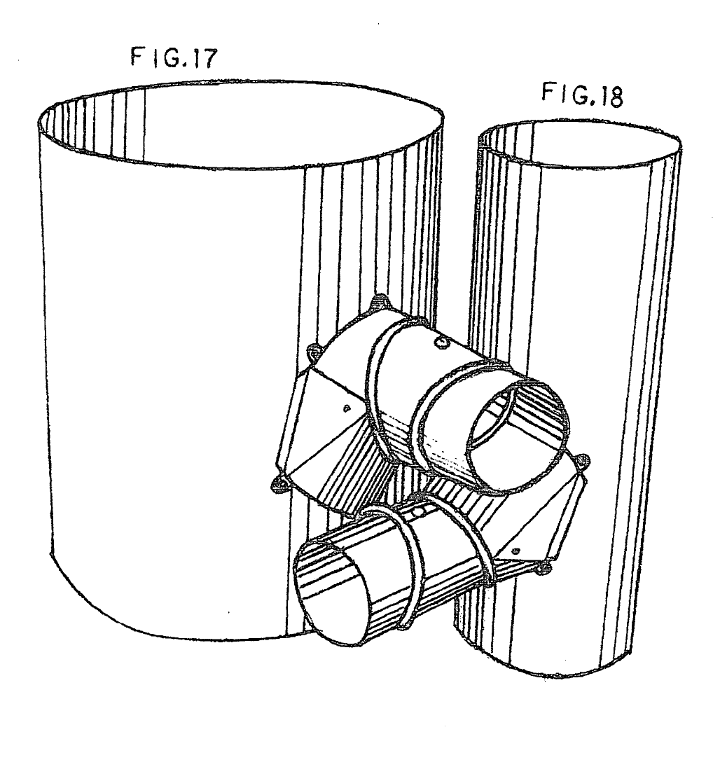

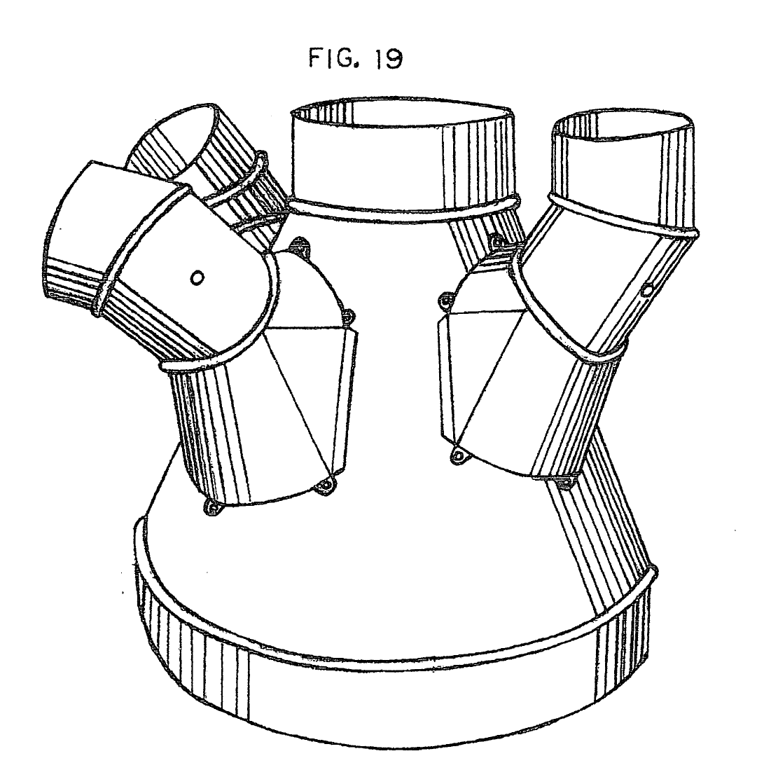

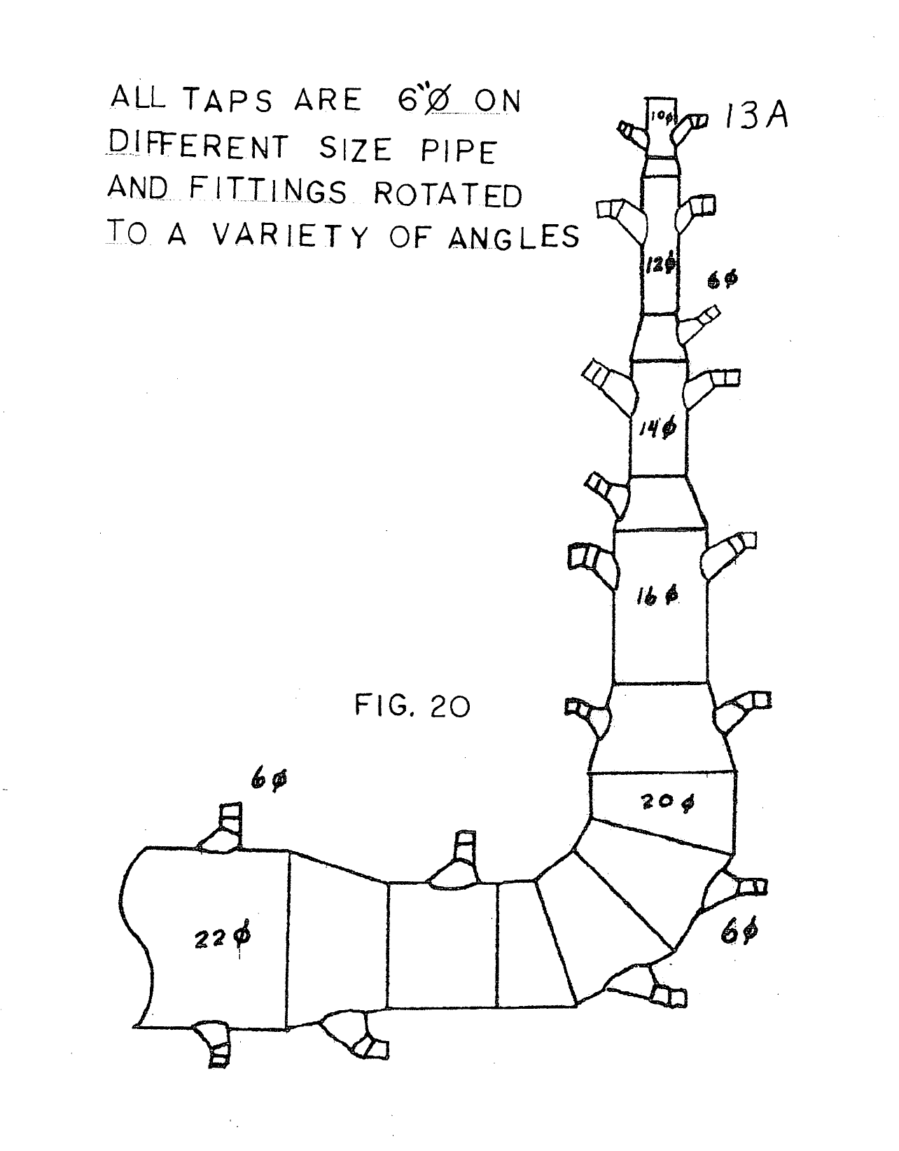

FIG. 4—Illustration shows in the upper left detail circle, collars 26 and 29 are rotatably attached to the upper body of the tap at bead 31 and can be manually adjustable to many angles as well as compound angles. The three parts have degree marks at their connecting bead lines which can be used for reference points when rotated so collars can have identical degrees or pitches when a multitude of them are installed on the same line, for ease of installation or visual effect in exposed or unexposed situations there by saving time.

The fitting has an interior extractor 50 there are two holes in the extractor blade 48 and 49 that aligns with 47 and 46, holes respectfully in the body of the fitting. The extractor has a restraining strap 52 which is attached to the upper edge of the extractor that has 3 holes in it 53-54 and 55 the extractor strap hangs down below extractor blade.

When the extractor is installed inside the fitting and is riveted thru holes 47 and 48 and 46 and 49. This attaches the extractor to the fitting, but still allows it to pivot on these points. The strap currently is bent so the holes 55 under tab 42 on the skirt aligns with hole 43 in the tab. This serves two purposes the attachment screw penetrates hole 43 and 55 when attached to the main line. In this position the extractor is secured out of the air stream. For more air said extractor 50 also it can be lowered prior to installation into the air stream.

By pulling the strap 52 down bending it out under tab 42 so hole 43 aligns with said hole 54 securing it is same procedure as before but this time it exposes more of the extractor strap between tab 42 and main line duct thus making it a multi purpose restraining and securing strap. The strap is also a multi position depth or use indicator. The detail in the upper left hand corner shows how the two collars 26 and 29 rotatably interlock with the upper body of the fitting 32.

Number 21 is a wing nut for the damper which secures 22 the wrench to 23 the damper quadrant is secured to 24 is the damper blade and 25 is secured to the damper blade it's use is to be able to penetrate hole 35 in collar 29 and 23 the damper quadrant is to penetrate hole 34 in the collar 29 when the damper blade is installed inside collar 29 and quadrant parts 23 and 25 protrude through holes 34 and 35 which gives pivoting and securing points for the damper blade 24 then the 22 the wrench is installed on 23 threads and the wing nut 21 secures 22 the wrench to 23 the damper quadrant which is standard sheet metal procedure. Detail in lower right hand corner shows attachment tab 36 with a hole and 37 in it. Number 38 shows the relief notch cut in the skirt so when tab 36 is bent out at an angle the tab will bend up in the skirt for a tighter fit to the main line. This is typical of the attachment tabs 41 is one of two stiffening and sealing flanges opposite side not shown which help, distorte the base of the saddle tap skirt to a some what of a tapering oval shape oblique to the main trunk line.

The saddle tap fitting is shipped in the FIG. 3 position for nesting purposes as well as for access to tab 42 and hole 43 after the hole which is slightly smaller than the skirt is cut in the main line pull down the extractor strap 52 which will lower extractor in the air stream to desired usage depth then bend strap under tab 42 so that desired hole 53 54 or 55 lines up with hole 43 then set tap over hole in the main line and install sharp screws thru the tab hole and the strap hole. Once that is done pull fitting back towards tab 36 this will distort fitting then install screw thru hole 37 once it is secured then install screws thru balance of tabs and holes tipping the sharp screw point away from the hole in the main line at a slight angle once the screw penetrates the main lines metal it will force the saddle taps skirt to conform to the main line of many different sizes after all screws are secured. Then the two collars 26 and 29 can be rotated to desired angles, Also the extractor strap will be exposed under tab 42 indicating the extractor's usage depth. Then install optional volume damper 24 volume damper in collars 29, thru holes 34 and 35 which is standard HVAC procedure. A necessary feature of the fitting is the six attachment tabs with their relief cuts on each side of them and their restraining and securing holes and the two stiffening and sealing flanges at the base of the skirt.

### Conclusions, Ramifications, and Scope of Invention

The saddle tap fitting is very useful and serves many functions by having the ability to tightly tap into new or existing HVAC main trunk lines of round or the arcuate sides of flat oval pipe and their associated fitting that make up said trunk lines. After a hole is cut in the main line and the saddle tap fitting is mounted over it and secured it will extract a large volume regulated conditioned air and efficiently direct it to a branch line at an angle or compound angles. The air flow can be in either direction supply return or exhaust. Another feature is its small size it makes it useful in very tight situations which exist in ceiling spaces attic's or crawl spaces. This saddle tap can be used in residential or commercial or industrial applications. With the use of this saddle tap fitting many sizes of dedicated wyes tees or prior art saddle taps can be eliminated or greatly reduced. The tight fitting saddle tap requires very little duct sealer.

This saddletap fitting has several features that are unobvious such as the attachment tabs have dual purpose holes in them which not only secure the skirt they are necessary to restrain the sharp screws needed when the large hole in the main line is cut and the saddletap at attachment time is mounted over the hole the sharp screws penetrate the tab hole and are tipped out at a slight angle away from the large hole in the main line. When the screws penetrate the main line this action stresses the skirt to adapt to the main line there by stressing and attaching the saddletap fitting to the main line. Another unobvious feature is the relief cut on both sides of the saddletaps tabs which is cut up in the skirt very slightly to allow the attachment tab to bend in the skirt its self instead of at the base of the skirt to ensure a tighter fit which saves leakage and duct sealer. Another unobvious feature attachment tab 42 and hole 43 they work in conjunction with extractor strap 52 and its adjusting and securing holes 53 54 55. There by securing the saddletap and the extractor as well when the saddletap is mounted to the main line. An additional unobvious feature the collars 26 29 are rotated at 90 degrees to the main line when shipped to allow the only access to tab 42 and hole 43 which is a necessary feature when attaching it to the main line to secure a tight fit. Another unobvious feature is its concealed extractor and its multi depth use indicator and securing strap.

Because of this saddletaps many features it will be a real asset to the HVAC industry in general. From the manufacturing companies who build it. The use of this saddle tap fitting will save the manufacturer the fabrication of complicated specific size fittings and the storage and inventory as well as the shipping of them. The capability for manufacturing one fitting for many sizes of applications and its nesting capabilities and storage will be a great asset to manufactures. The distributor can take advantage the capabilities as well plus the availability problems will be greatly reduced. The HVAC company can have the same advantage they won't have to stock a wide variety of fittings or hunt for them. These features will save the manufacturer the distributor and the HVAC company that installs them time and money which could be passed on to the consumer. The use of this saddle tap fitting will create jobs save resources use less energy and help the environment. With respect it maybe some what obvious that the saddle tap may fit a round surface it is unobvious that it will distort to tightly adapt too many sizes of round surfaces of pipe or round tapers or arcuate sides of flat oval pipe or oval to round tapers or round to oval tapers.

This saddle tap has many capabilities and uses. I have many working models of this saddle tap invention in various sizes.

Example one 4 inch diameter branch line saddle tap fitting will fit over fifty different applications or combinations of round and oval pipe and there associated fittings such as tapers reducers etc all of the features will make this saddle tap a real asset to the HVAC construction and other industries.

What is claimed is:

1. A saddle tap tee fitting for heating ventilating and air conditioning known as HVAC duct comprising.
1. A fitting for attaching an end of a hollow duct section of a relatively small circular cross section to a hollow arcuate surface of a duct section of a relatively large cross section. A first circular cylindrical collar that has a hollow interior and said first end which is perpendicular to the collar. A second end of said first collar is oblique to the axis which has a arc shaped bead around its circumference. That rotatably interlocks with a corresponding first bead on the second collar.
A second hollow cylindrical collar has oblique to the axis a first end with a arc shaped bead around its circumference on a second end of said collar oblique to the axis disposed is a second arc shaped bead around its circumference that rotatably interlocks with a corresponding bead on upper body.
2. A body having a hollow generally circular upper portion terminating in a generally circular end oblique to the axis at a predetermined angle. A arc shaped bead around said end. Collectively said first collars first bead rotatably interlocks with second collars first bead said collars second bead rotatably interlocks with said bead on upper body of saddle tap fitting.
3. A body having a skirt flairing downwardly a distance from said body's circular upper end. Said skirt terminating in a base to said body's upper portion end. Said skirt having a generally opposed first and second longitudinal and diagonal flanges terminating respectively in a canted angle off the base of said skirt. Said base determined by said flanges and a plurality of perforated and relief notched attachment tabs and a small slanted arc shaped forward and a slanted larger arc shaped rearward arc. Said base arcs at its ends is disposed between said tabs and contiguous said flanges. At center of the forward and rearward arcs are additional intrical attachment tabs one on each said arc respectively. The saddle tap having a interior pivotal air extractor with securing indicating adjustment strap and associated holes in said strap and extractor.
4. The fitting of claim 1, wherein said first and second collars have degree marks on or at said connecting beads. These are for reference for adjustment in like alignment for the collars and the body of the saddletap fitting. In a multitude of like saddletap situations or angles.
5. The fitting of claim 1, wherein said second collar has two opposite holes at its center for the pivoting and securing and adjusting therein for a future installation of a volume damper and assorted hardware.
6. The fitting of claim 1, the first collar of the saddletap can be rotated to many angles in relationship with the main line.
7. The fitting of claim 2, the second collars second bead rotatably interlocks with a corresponding bead on the upper body both beads have degree marks on or at them for alignment or adjustment in like situations.
8. The fitting of claim 1, the alignment of degree marks on both collars and said upper body cooperate to duplicate like angles off of the upper body of the fitting whereas the a plurality of saddletaps can have like alignment thereby saving time and aesthetics.
9. The fitting of claim 3, the saddletap has an interior adjustable air extractor that can be set to different depths.
10. The fitting of claim 3, the said extractor has a multi depth exposed use indicator and restraining strap.
11. The fitting of claim 3, the said extractor has a crimped leading edge on it to give it a enhanced scooping effect when engaged in the air stream for a large volume of conditioned air.
12. The fitting of claim 3, the skirt of the said saddletap is cut at an angle to the main line for greater volume of air to or from the main line saving energy.
13. The fitting of claim 3, at the base of the said skirt is a plurality of attachment tabs with said holes in them for securing the saddletap when the screws are run through then to the main line.
14. The fitting of claim 3, said attachment tab holes are necessary to restrain sharp screws from drifting around when said screws are tilted at a slight angle through said holes to help stress the fitting skirt to the main line at the time of attachment.
15. The fitting of claim 3, the said attachment tabs have a small relief notch on each side of them into the skirt so when the tab is bent out to receive screw said tab will bend up in said skirt instead of at its base this makes for a tighter fit to the main line.
16. The fitting of claim 3, the said skirt has two opposing angles used for stiffening sealing and forming the base of the skirt.
17. The fitting of claim 3, the said fittings interior extractor which is installed at the factory doesn't diminish its nesting abilities.
18. The fitting of claim 3, the said interior air extractor flexibly adapts to any pipe or fitting the saddletap is attached to.
19. The fitting of claim 3, when attached appears to be specifically built for the pipe or fitting it is attached to for aesthetics.
20. The fitting of claim 3, the saddletaps collars are adjusted from the factory at 90 degrees off the main line for the only access to said tab 43 and said hole 42 this is necessary to ensure a tight fit.
